(19) United States
(12) Patent Application Publication
(10) Pub. No.: US 2016/0275280 A1
(43) Pub. Date: Sep. 22, 2016

(54) REMOTE AUTHENTICATION OF IDENTITY

(71) Applicants: Boris Gill, Playa Del Rey, CA (US); Aleksandre Okmianski, Atherton, CA (US)

(72) Inventors: Boris Gill, Playa Del Rey, CA (US); Aleksandre Okmianski, Atherton, CA (US)

(21) Appl. No.: 15/064,271

(22) Filed: Mar. 8, 2016

Related U.S. Application Data
(60) Provisional application No. 62/135,426, filed on Mar. 19, 2015.

(51) Int. Cl. G06F 21/32; G06F 17/30

(52) U.S. Cl. CPC G06F 21/32; G06F 17/30256

(57) ABSTRACT

A method of identifying a person by remotely processed data by an identifying party. A person pre-registers a biometric signature with a security service provider. At the time identification authentication is needed, the person is scanned by a camera having a display screen facing the same direction as the camera input lens. The security service provider superimposes optically discernible arbitrarily selected indicia over the image captured by the camera in real time. Imagery captured by the camera, if authentic, will reflect both the digitized characteristic and also the arbitrarily selected indicia for authenticity processing. Authentication is verified if the pre-registered biometric signature matches the biometric signature from the image, and the arbitrarily selected indicia captured in the image matches that provided by the security service provider.

### REFERENCE TO RELATED APPLICATION

This application claims priority to U.S. Provisional Patent Application No. 62/135,426, filed Mar. 19, 2015, the content of which is hereby incorporated by reference in its entirety.

### FIELD OF THE DISCLOSURE

The present disclosure relates to remote authentication of identity of people.

### BACKGROUND

In today's economy, many people conduct commercial transactions, pass through security checkpoints, and do other things based on automated authentication of identity. One of the more unique characteristics of people, which characteristics can be the basis of identifying a person's identity, includes the field of biometrics. For example, iris patterns provide a unique identifying characteristics of a person. However, as iris patterns and other biometric and other characteristics are handled electronically given today's digital technologies, these characteristics become susceptible to being stolen or reproduced illicitly.

### SUMMARY

A method of identifying a person is disclosed, which address the above stated situation by providing a solution to illicit authentications due to stolen or illicitly reproduced digitized characteristics. In the method, a person pre-registers a biometric signature with a security service provider. At the time identification authentication is needed, the person is scanned by a camera having a display screen facing the same direction as the camera input lens. The security service provider superimposes optically discernible arbitrarily selected indicia over the image captured by the camera in real time. Imagery captured by the camera, if authentic, will reflect both the digitized characteristic and also the arbitrarily selected indicia for authenticity processing.

Even if the characteristics of the person being authenticated have been captured by an unauthorized party, that party cannot predict the arbitrarily selected indicia, and hence cannot present a full and authenticatable identity to the security service provider.

This occurs when the camera and screen are combined, and are linked to a communications network. Cellular telephones can be used for such a camera. Cellular telephones provide the camera, the display screen, contents of which are projected onto the person being authenticated, and can receive and display the arbitrarily selected indicia. Note that it is fully appreciated by the applicant that the present utility disclosure would be usable on all types of communications devices that provide the same functional features as described above for mobile communications devices such as a cellular phone. Such other communications devices may include, and in no way is this list intended to be limiting, tablet computers, desktop computers, laptop computers, notebook computers etc.

The disclosed concept will become readily understandable upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a schematic perspective view of apparatus for implementing a method of identifying a person, according to at least one aspect of the disclosure;

FIG. 2A is a block diagram showing a method of identifying a person, according to at least one aspect of the disclosure;

FIG. 2B is a block diagram showing a further aspect of the method of FIG. 2;

FIG. 2C is a block diagram showing another aspect of the method of FIG. 3; and

FIG. 3 is a block diagram showing the method of FIG. 2 in a fuller implementation, and apparatus used in the fuller implementation.

### DETAILED DESCRIPTION

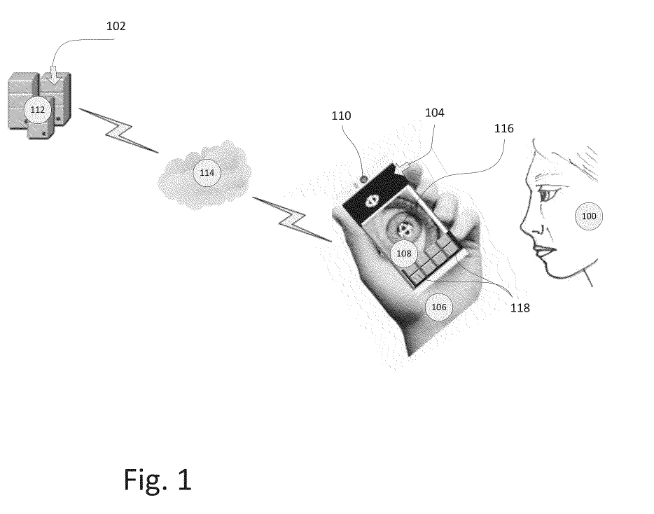

Referring first to FIG. 1, according to at least one aspect of the disclosure, there is shown apparatus used in implementing a method of identifying a person by remotely processed data by identifying party 102. The person being identified may or may not be person 100 illustrated in FIG. 1. Identifying party 102, shown only schematically in FIG. 1, may be an organization of people, such as a commercial company acting in the capacity of a commercial security provider, and physical premises suitable for housing and operating server 112.

The apparatus includes mobile communications device 104, such as a cellular telephone, shown held in the hand 106 of person 100 being identified. Mobile communications device 104 includes display screen 108, a camera 110 (not shown in its entirety, but represented by the camera input lens) which faces the same direction as display screen 108, and remote server 112 (remote from mobile communications device 104). Mobile communications device 104 is operable to communicate with remote server 112 via a communications network, such as the internet 114. Note that it is fully appreciated by the applicant that the present utility disclosure would be usable on all types of communications devices that provide the same functional features as described above for mobile communications devices such as a cellular phone. Such other communications devices may include, and in no way is this list intended to be limiting, tablet computers, desktop computers, laptop computers, notebook computers etc.

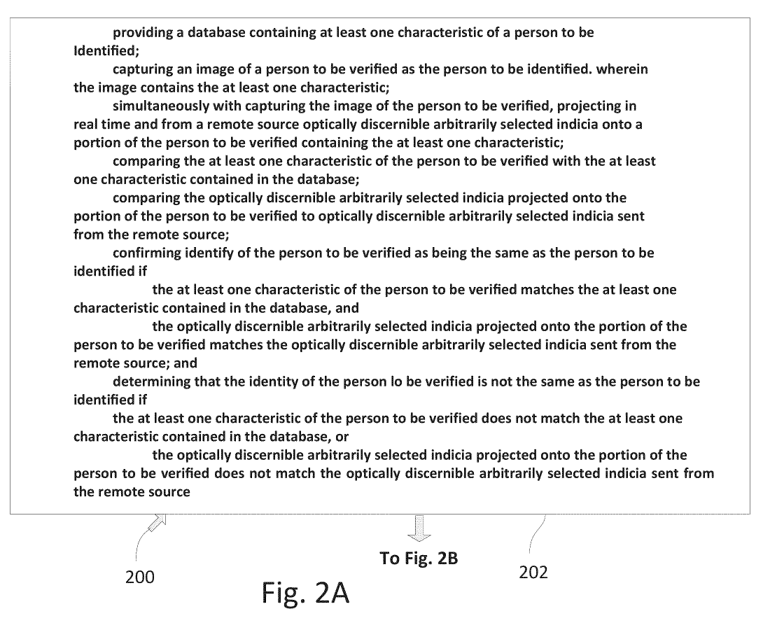

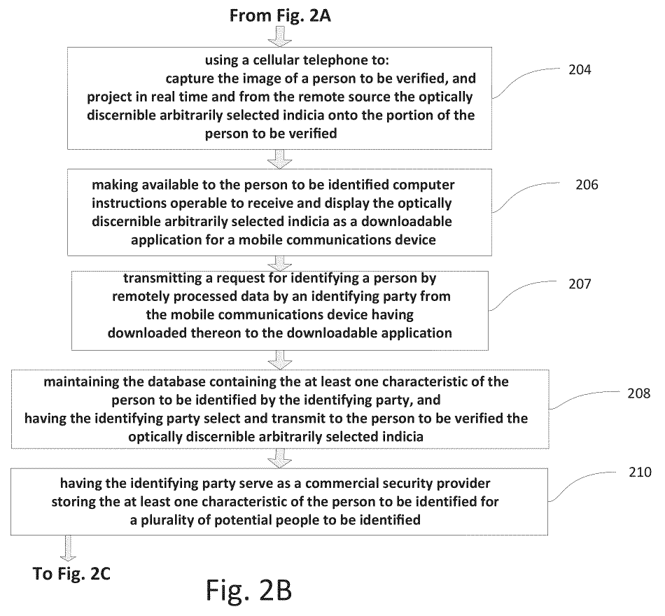

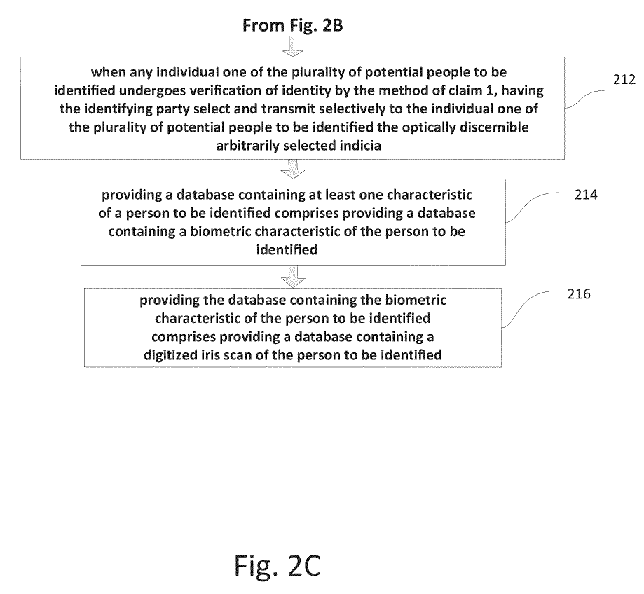

Referring also to block 202 of FIG. 2A, a method 200 of identifying the person to be identified by remotely processed data by identifying party 102 comprises providing a database containing at least one characteristic of the person to be identified, capturing an image of person 100 to be verified as the person to be identified, wherein the image contains the at least one characteristic, and simultaneously with capturing the image of person 100 to be verified, projecting in real time and from a remote source optically discernible arbitrarily selected indicia 116 onto a portion of person 100 to be verified containing the at least one characteristic. Method 200 further comprises comparing the at least one characteristic of person 100 to be verified with the at least one characteristic contained in the database, comparing optically discernible arbitrarily selected indicia 116 projected onto the portion of person 100 to be verified to optically discernible arbitrarily selected indicia sent from the remote source. Method 200 further comprises confirming identify of person 100 to be verified as being the same as the person to be identified if the at least one characteristic of person 100 to be verified matches the at least one characteristic contained in the database, and optically discernible arbitrarily selected indicia 116 projected onto the portion of person 100 to be verified matches the optically discernible arbitrarily selected indicia sent from the remote source. Method 200 further comprises determining that the identity of person 100 to be verified is not the same as the person to be identified if the at least one characteristic of person 100 to be verified does not match the at least one characteristic contained in the database, or optically discernible arbitrarily selected indicia 116 projected onto the portion of person 116 to be verified does not match the optically discernible arbitrarily selected indicia sent from the remote source.

The database containing at least one characteristic of the person to be identified is stored in a memory (not separately shown) of server 112. Server 112 is the remote source, in that person 100 to be verified will be located remotely from identifying party 102 and server 112.

The image of person 100 to be verified as the person to be identified is captured by the camera 100.

The arbitrarily selected indicia 116 is in the example of FIG. 1 the letter “X”. Arbitrarily selected indicia 116 is projected from screen 108 of mobile communications device 104 to a portion of person 100, such as the face. The portion of person 100 is near that portion of person 100 containing the at least one characteristic.

Method 200 may further comprise, as seen in block 204 of FIG. 2B, using a cellular telephone to capture the image of person 100 to be verified, and project in real time and from the remote source optically discernible arbitrarily selected indicia 116 onto the portion of person 100 to be verified. That is, mobile communications device 104 may be a cellular telephone of the type having display screen 108 and camera 110 on the same side. Mobile communications device 104 may also include key switches 118 as a user interface for accepting commands from person 100, and an internal memory and a data processor (neither separately shown).

Method 200 may further comprise, as seen in block 206 of FIG. 2B, making available to person 100 to be identified computer instructions operable to receive and display optically discernible arbitrarily selected indicia 116 as a downloadable application for mobile communications device 104.

Method 200 may further comprise, as seen in block 207 of FIG. 2B, transmitting a request for identifying person 100 by remotely processed data by identifying party 102 from mobile communications device 104 having downloaded thereonto the downloadable application. That is, person 100 may request identifying party 102 to provide authentication of identity, using his or her own mobile communications device 104.

Method 200 may further comprise, as seen in block 208 of FIG. 2B, maintaining the database containing the at least one characteristic of person 100 to be identified by identifying party 102, and having identifying party 102 select and transmit to person 100 to be verified optically discernible arbitrarily selected indicia 116.

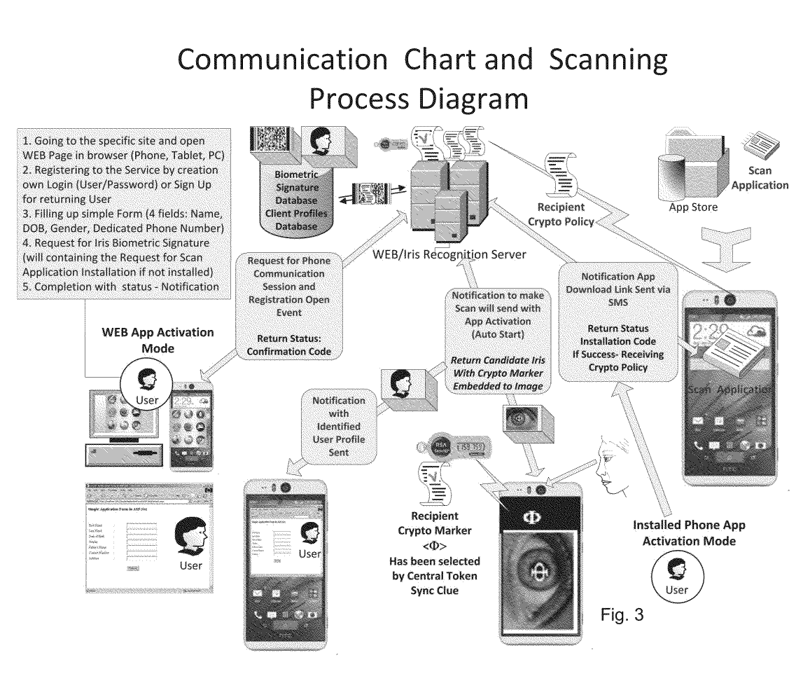

Method 200 may further comprise, as seen in block 210 of FIG. 2B, having identifying party 102 serve as a commercial security provider storing the at least one characteristic of person 100 to be identified for a plurality of potential people to be identified. People wishing to obtain identity authentication services from identifying party 102 may do so for example on a subscription basis. A more detailed description of such an arrangement is set forth as a fuller implementation of method 200 in FIG. 3.

Referring to block 212 of FIG. 2C, method 200 may further comprise, when any individual one of the plurality of potential people to be identified undergoes verification of identity by method 200 in any of its several implementations, having identifying party 102 select and transmit selectively to the individual one of the plurality of potential people to be identified optically discernible arbitrarily selected indicia 116. Control of the verification process is thereby held by identifying party 102.

Referring to block 214 of FIG. 2C, in method 200, providing a database containing at least one characteristic of person 100 to be identified comprises providing a database containing a biometric characteristic of person 100 to be identified. Biometric characteristics are useful since they are part of the body of person 100 to be identified, and are sufficiently unique as to provide proper identification.

Referring to block 216 of FIG. 2C, in method 200, providing the database containing the biometric characteristic of person 100 to be identified comprises providing a database containing a digitized iris scan of person 100 to be identified. The iris provides an easily imaged portion of the body of person 100, the iris also being highly unique to individuals.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A method of identifying a person by remotely processed data by an identifying party, comprising:
providing a database containing at least one characteristic of a person to be identified;
capturing an image of a person to be verified as the person to be identified, wherein the image contains the at least one characteristic;
simultaneously with capturing the image of the person to be verified, projecting in real time and from a remote source optically discernible arbitrarily selected indicia onto a portion of the person to be verified containing the at least one characteristic;
comparing the at least one characteristic of the person to be verified with the at least one characteristic contained in the database;
comparing the optically discernible arbitrarily selected indicia projected onto the portion of the person to be verified to optically discernible arbitrarily selected indicia sent from the remote source;
confirming identify of the person to be verified as being the same as the person to be identified if
the at least one characteristic of the person to be verified matches the at least one characteristic contained in the database, and
the optically discernible arbitrarily selected indicia projected onto the portion of the person to be verified matches the optically discernible arbitrarily selected indicia sent from the remote source; and
determining that the identity of the person to be verified is not the same as the person to be identified if
the at least one characteristic of the person to be verified does not match the at least one characteristic contained in the database, or
the optically discernible arbitrarily selected indicia projected onto the portion of the person to be verified does not match the optically discernible arbitrarily selected indicia sent from the remote source.

2. The method of claim 1, further comprising using a cellular telephone to:
capture the image of a person to be verified, and
project in real time and from the remote source the optically discernible arbitrarily selected indicia onto the portion of the person to be verified.

3. The method of claim 2, further comprising making available to the person to be identified computer instructions operable to receive and display the optically discernible arbitrarily selected indicia as a downloadable application for a mobile communications device.

4. The method of claim 3, further comprising transmitting a request for identifying a person by remotely processed data by an identifying party from the mobile communications device having downloaded thereonto the downloadable application.

5. The method of claim 1, further comprising:
maintaining the database containing the at least one characteristic of the person to be identified by the identifying party, and
having the identifying party select and transmit to the person to be verified the optically discernible arbitrarily selected indicia.

6. The method of claim 1, further comprising having the identifying party serve as a commercial security provider storing the at least one characteristic of the person to be identified for a plurality of potential people to be identified.

7. The method of claim 1, further comprising, when any individual one of the plurality of potential people to be identified undergoes verification of identity by the method of claim 1, having the identifying party select and transmit selectively to the individual one of the plurality of potential people to be identified the optically discernible arbitrarily selected indicia.

8. The method of claim 1, wherein providing a database containing at least one characteristic of a person to be identified comprises providing a database containing a biometric characteristic of the person to be identified.

9. The method of claim 8, wherein providing the database containing the biometric characteristic of the person to be identified comprises providing a database containing a digitized iris scan of the person to be identified.
